(19) United States
(12) Patent Application Publication
(10) Pub. No.: US 2024/0428761 A1
(43) Pub. Date: Dec. 26, 2024

(54) ELECTRONIC INSTRUMENT AND ELECTRONIC KEYBOARD INSTRUMENT

(71) Applicant: CASIO COMPUTER CO., LTD., Tokyo (JP)

(72) Inventors: Hiroki AKAI, Tokyo (JP); So SATO, Tokyo (JP)

(21) Appl. No.: 18/751,448

(22) Filed: Jun. 24, 2024

(30) Foreign Application Priority Data
Jun. 26, 2023 (JP) 2023-103894

(51) Int. Cl. G10H 1/32; G10C 3/02; G10C 3/12

(52) U.S. Cl. CPC G10H 1/32; G10C 3/02; G10C 3/12

(57) ABSTRACT

An electronic instrument includes a casing, at least one performance element on the casing, a sound emitting unit inside the casing, and a cover unit configured to be accommodated between the performance element and the sound emitting unit inside the casing by being pushed into and pulled out of the casing and to cover the performance element with the cover unit pulled out of the casing, and an interior of the casing is divided by the cover unit into a first space where the performance element is disposed and a second space where the sound emitting unit is disposed with the cover unit accommodated inside the casing, and a recess is provided on a plate surface lying near the cover unit inside the casing in such a manner as to straddle the first space and the second space.

### CROSS-REFERENCE TO RELATED APPLICATION

This application is based upon and claims the benefit of priority under 35 USC 119 of Japanese Patent Application No. 2023-103894 filed on Jun. 26, 2023, the entire disclosure of which, including the specification, claims, drawings and abstract, is incorporated herein by reference in its entirety.

### BACKGROUND

### Technical Field

The present disclosure relates to an electronic instrument and an electronic keyboard instrument.

### Description of the Related Art

In conventional electronic keyboard instruments that can provide a key press feeling and tones which are closer to those provided by a real piano, there are known some electronic keyboard instruments in which a key cover for covering a keyboard is accommodated in an interior of a casing. For example, Japanese Unexamined Patent Application Publication No. 2012-145803 (JP-A-2012-145803) discloses an electronic keyboard instrument including an instrument main body, a keyboard section disposed in an interior of the instrument main body, a surface loudspeaker unit disposed at a back portion of the instrument main body, and a keyboard lid disposed in the instrument main body. In this electronic keyboard instrument, the keyboard lid is made up of a front lid and a back lid which are rotatably coupled together and is configured to cover the keyboard section from above in a closed state and to open the keyboard section to enable the play of the electronic keyboard instrument in an opened state.

### SUMMARY

According to an aspect of the present disclosure, there is provided an electronic instrument including a casing, at least one performance element provided in connection with the casing, a sound emitting unit provided in an interior of the casing and a cover unit configured to be accommodated between the at least one performance element and the sound emitting unit in the interior of the casing by being pushed into and pulled out of the interior of the casing and to cover the at least one performance element in a state in which the cover unit is pulled out of the interior of the casing, wherein the interior of the casing is divided by the cover unit into a first space on a side where the at least one performance element is disposed and a second space on a side where the sound emitting unit is disposed in a state in which the cover unit is accommodated in the interior of the casing, and wherein a recess is provided on a plate surface lying near the cover unit in the interior of the casing in such a manner as to straddle the first space and the second space.

According to another aspect of the present disclosure, there is provided an electronic keyboard instrument including the electronic instrument described above, wherein the electronic instrument comprises multiple performance elements, and the multiple performance elements include a keyboard.

### BRIEF DESCRIPTION OF THE DRAWINGS

FIG. 1 is an overall perspective view of an electronic keyboard instrument according to an embodiment of the present disclosure as viewed from a front side;

FIG. 2 is a perspective view of a main body part of the electronic keyboard instrument according to the embodiment of the present disclosure as viewed from a back side, with a back plate removed;

FIG. 3 is a plan view of the main body part of the electronic keyboard instrument according to the embodiment of the present disclosure, with a front top plate and a back top plate removed;

FIG. 4 is an enlarged view of surroundings of recesses in FIG. 3 according to the embodiment of the present disclosure;

FIG. 5 is a sectional view of the main body part of the electronic keyboard instrument according to the embodiment of the present disclosure taken along a line V-V in FIG. 2; and

FIG. 6 is a sectional perspective view of the main body part of the electronic keyboard instrument according to the embodiment of the present disclosure, with a section corresponding to the sectional view of FIG. 5.

### DESCRIPTION OF THE EMBODIMENTS

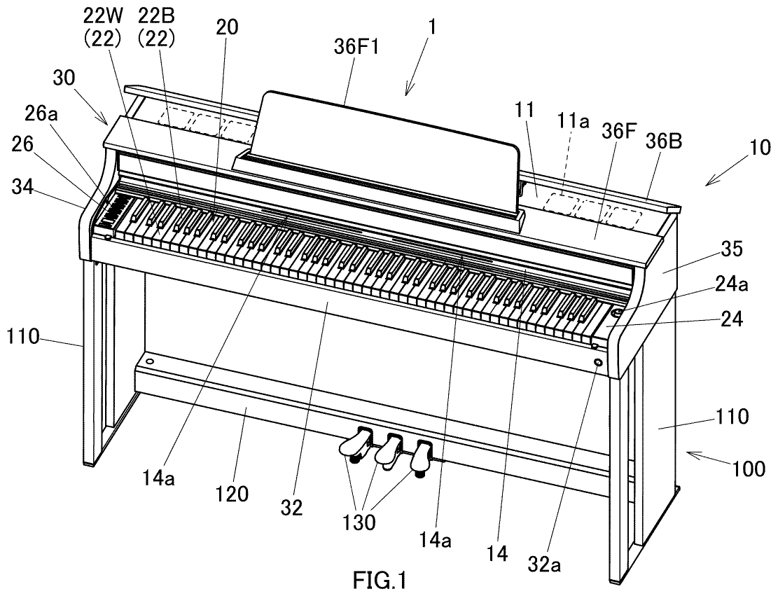

Hereinafter, referring to drawings, an embodiment of the present disclosure will be described. An electronic keyboard instrument (an electronic instrument) 1 shown in FIG. 1 includes a main body part 10 and a leg part 100. As shown in FIG. 1, the main body part 10 includes a keyboard (multiple performance elements) 20 and a main body case (a casing) 30 which encompasses the keyboard 20 to hold it. The keyboard 20 has multiple keys 22 made up of white keys 22W and black keys 22B, and a key press section of the keyboard 20 is exposed. The leg part 100 includes a pair of side plates 110, a pedal frame 120, and a pedal device 130. In the following description, an alignment direction of the multiple keys 22 of the keyboard 20 is referred to as a left-right direction (in FIG. 1, a direction towards a left side is referred to as a leftward direction), an extending direction of each key 22 is referred to as a front-back direction (in FIG. 1, a direction towards a nearer side is referred to as a forward direction), and an upper-lower direction of the electronic keyboard instrument 1 is referred to as an upper-lower direction (in FIG. 1, a direction towards an upper side is referred to as an upward direction).

As shown in FIG. 1, the pair of side plates 110 are component plates which are erected on a setting surface on both left and right sides of the electronic keyboard instrument 1 in such a posture that two plate surfaces of each component plate are oriented in the left-right direction so as to support the main body case 30. The pedal frame 120 extends between the side plates 110 to connect them together at lower end portions of the side plates 110. The pedal device 130 is provided at a substantially central portion of the pedal frame 120 in the left-right direction. In the electronic keyboard instrument 1, the main body case 30 of the main body part 10 and both the side plates 110 of the leg part 100, which are both exposed to an exterior of the electronic keyboard instrument 1, are made of wood, and this features the quality of the electronic keyboard instrument 1. Hereinafter, the configuration of the main body port 10 will be described in detail.

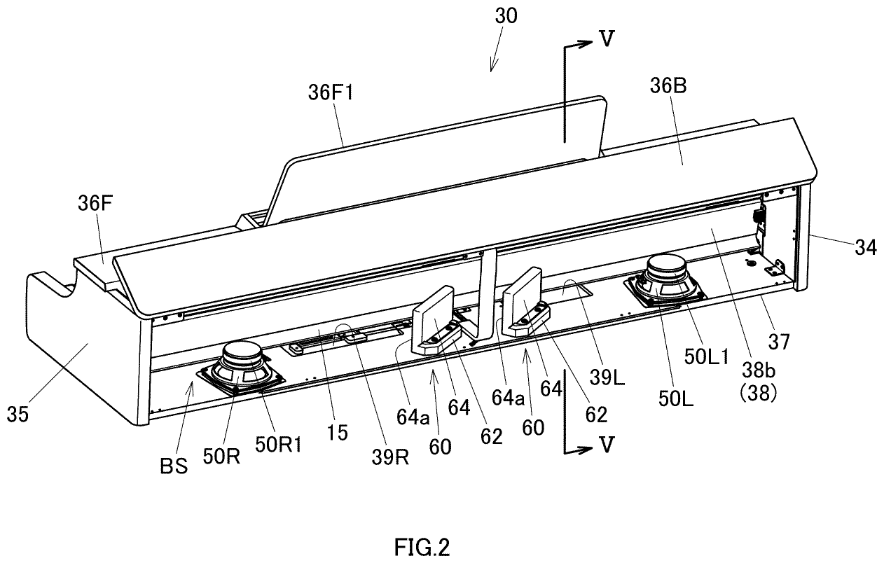

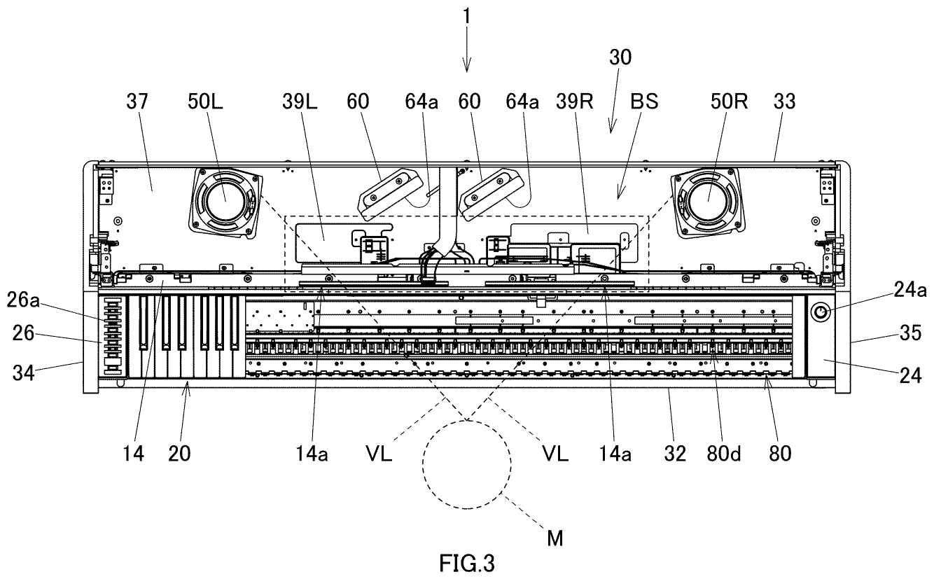

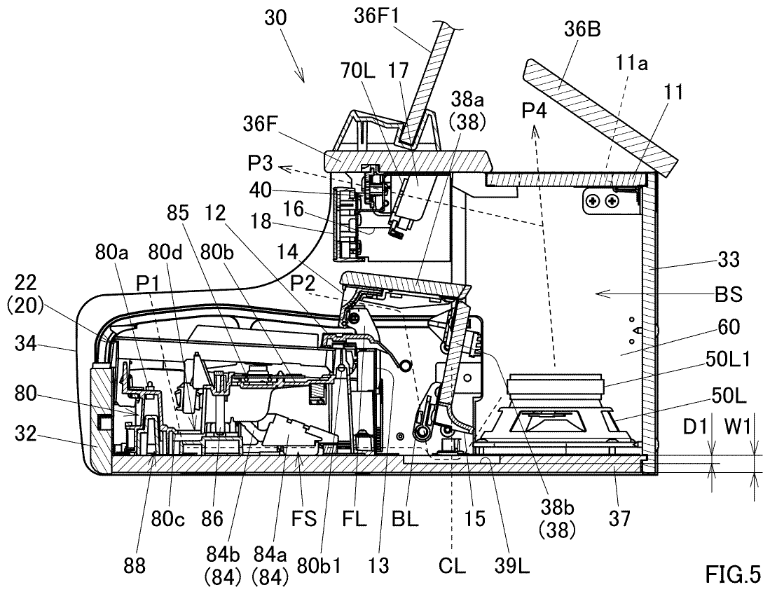

As shown in FIGS. 1 to 3, when viewed from an upper side and a lower side thereof, the main body case 30 has a laterally elongated, substantially rectangular shape in which a longitudinal direction follows the left-right direction and has thick component plates such as a front plate 32, a back plate 33, a left side plate 34, a right side plate 35, a front top plate 36F, a back top plate 36B, and a lower plate 37 (a bottom plate). In addition, the main body case 30 has a substantially L-shaped vertical section (refer to FIG. 5). Here, in FIG. 2, the main body case 30 is shown being in a state in which the back plate 33 is removed, and in FIG. 3, the main body case 30 is shown being in a state in which the front top plate 36F and the back top plate 36B are removed. The front plate 32 has a substantially rectangular shape which is elongated in the left-right direction and is provided at a lower portion of a front end portion of the main body part 10 and on a lower side of the keyboard 20, constituting a front surface of the main body case 30. A power supply button 32a is provided at a right end portion of the front plate 32 (refer to FIG. 1). The back plate 33 has a substantially rectangular shape which is elongated in the left-right direction and is provided on a back side of the main body part 10, constituting a back surface of the main body case 30.

The left side plate 34 and the right side plate 35 each have a substantially rectangular shape which is elongated in the front-back direction. In each of the left side plate 34 and the right side plate 35, A step is provided at a substantially central portion in the front-back direction so that the height of a front half portion becomes substantially equal to the height of the keyboard 20. The left side plate 34 and the right side plate 35 are provided individually on a left side and a right side of the main body part 10, constituting a left side surface and a right side surface of the main body case 30, respectively. The front top plate 36F has a substantially rectangular shape which is elongated in the left-right direction and is provided on a front side of an upper backward portion of the main body part 10, constituting a part of an upper surface of the main body case 30. The back top plate 36B has a substantially rectangular shape which is elongated in the left-right direction and is provided on a back side of the upper backward portion of the main body part 10, constituting another part of the upper surface of the main body case 30. Here, as shown in FIGS. 1 and 3, a volume panel 24 on which a volume knob 24a and the like are disposed is provided between the keyboard 20 and the right side plate 35. In addition, a setting panel 26 on which various types of setting buttons 26a are disposed is provided between the keyboard 20 and the left side plate 34.

As shown in FIGS. 1 and 5, the back top plate 36B is attached rotatably to the back plate 33 in such a manner that the back plate 33 is opened from a front side thereof. A cover plate 11, having a substantially rectangular plate-like shape which is elongated in the left-right direction, is provided on a lower side of the back top plate 36B in such a posture that two plate surfaces thereof are oriented in the upper-lower direction. Multiple upper openings 11a, each having a substantially rectangular shape and opened upwards, are provided in the cover plate 11 in such a manner as to be disposed at predetermined intervals in the left-right direction (refer to FIG. 5). An upper surface and side surfaces of the cover plate 11 are covered with a saran net. With the back top plate 36B left open, an opening on a lower side of the back top plate 36B is covered by the cover plate 11 so that an interior of the main body case 30 is made invisible. In addition, a music stand 36F1 is attached to a substantially central portion of the front top plate 36F in the left-right direction thereof. The lower plate 37 has a substantially rectangular shape which is elongated in the left-right direction and is provided on a lower side of the main body case 30, constituting a lower surface of the main body case 30.

As shown in FIGS. 3 and 5, a console unit 12, having a substantially rectangular plate-like shape which is elongated in the left-right direction, is provided on back sides of the keys 22 of the keyboard 20 in such a posture that two plate surfaces thereof are oriented in the upper-lower direction. The console unit 12 is provided in such a manner as to cover back end portions of the keys 22 of the keyboard 20 in a position where the console unit 12 overlaps a front end portion of the front top plate 36F in the upper-lower direction. The console unit 12 prevents the interior of the main body case 30 from becoming visible via a gap at a back end portion of the keyboard 20 from an exterior of the electronic keyboard instrument 1. In addition, the keys 22 are restricted from moving in the front-back direction by providing the console unit 12 on the back sides of the keys 22.

As shown in FIG. 5, multiple first metallic sheets 13 are provided at a back end portion of a lower surface of the console unit 12 in such a manner as to be disposed at predetermined intervals along the left-right direction. The multiple first metallic sheets 13 each have a substantially plate-like shape and extend downwards in such a posture that two sheet surfaces thereof are oriented in the front-back direction. Lower end portions of the first metallic sheets 13 are attached to the lower plate 37. A back side of the keyboard 20 is fixed to the main body case 30 by the first metallic sheets 13. A space defined on front sides of the first metallic sheets 13 constitutes a space provided below the keyboard 20. Multiple notches, not shown, are provided individually in lower end portions of the first metallic sheets 13. In the interior of the main body case 30, the space defined on the front sides of the first metallic sheets 13 and a space defined on back sides of the first metallic sheets 13 are made to communicate with each other via interspaces between the multiple first metallic sheets 13 and the notches provided in the first metallic sheets 13.

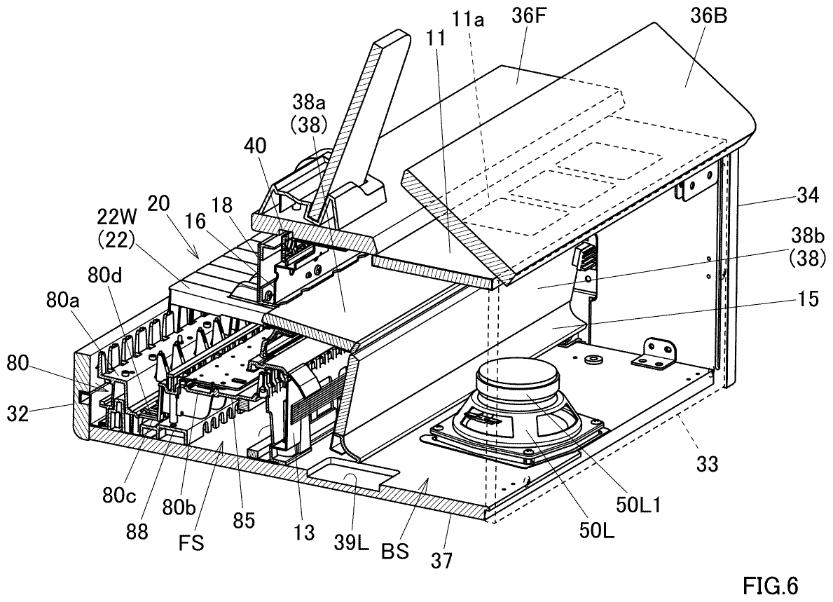

As shown in FIG. 5, in the main body case 30, a section defined between the front plate 32 and the console unit 12 is opened forwards and upwards, so that upper surfaces, constituting key press portions, and portions of front surfaces of the keys 22 of the keyboard 20 are exposed to the outside from this open section. As shown in FIGS. 5 and 6, the main body part 10 includes a key cover 38 (a cover unit) for covering a section of the keyboard 20 which is exposed to the outside. The key cover 38 is a thick component plate and is made up of a front cover section (a first cover) 38a and a back cover section (a second cover) 38b, which are each made up of a component plate having a substantially rectangular shape which is elongated in the left-right direction. Then, the front cover section 38a and the back cover section 38b are aligned parallel in the front-back direction. The front cover section 38a is rotatably connected with a front link FL which is fixed to the main body case 30 via a laterally elongated, substantially rectangular front attachment 14.

The back cover section 38b is rotatably connected with a back link BL which is fixed to the main body case 30 via a laterally elongated, substantially rectangular back attachment 15. The front cover section 38a and the back cover section 38b are coupled together via a hinge in such a manner as to be folded into two sections and are accommodated in the space defined on the back sides of the first metallic sheets 13 in the interior of the main body case 30 in such a manner that the key cover 38 can freely be pushed into and pulled out of the relevant space through a gap defined between the console unit 12 and an operation plate 18, which will be described later. In the present embodiment, the key cover 38 is folded into the two sections so as to be accommodated in the interior of the main body case 30 to thereby save the space in the interior of the main body case 30. Here, two laterally elongated, substantially rectangular attachment openings (communication holes) 14a are provided individually on a left side and a right side of a central portion (a hand-held section) of the front attachment 14 in the left-right direction in such a manner as to be opened to penetrate the front attachment 14 (refer to FIG. 1 and the like).

As shown in FIG. 5, the front cover section 38a is accommodated in the space defined on the back sides of the first metallic sheets 13 in such a posture that the front cover section 38a becomes substantially horizontal or parallel to the lower plate 37 in the upper-lower direction, while the back cover section 38b is accommodated in the space defined on the back sides of the first metallic sheets 13 in such a posture that the back cover section 38b becomes substantially perpendicular to the lower plate 37. With the front cover section 38a accommodated in the space on the back sides of the first metallic sheets 13, the front attachment 14 adopts such a posture that the front attachment 14 covers a gap defined between the back end portion of the keyboard 20 and the front cover section 38a, whereby the front attachment 14 prevents the interior of the main body case 30 from being visible from the exterior of the electronic keyboard instrument 1 (a concealing function). In the electronic keyboard instrument 1, the opening in the main body case 30 where the keyboard 20 is exposed is configured to be covered by the key cover 38 by pulling it out of the interior of the main body part 10 after the play is completed or the like.

In the electronic keyboard instrument 1, with the keyboard 20 left covered by the key cover 38, the gap defined between the console unit 12 and the operation plate 18 is covered by the back attachment 15. Additionally, when the power supply is switched on and the key cover 38 is accommodated in the space defined on the back sides of the first metallic sheets 13, a slight gap is defined between the lower plate 37 and the back attachment 15. In consequence of this, with the key cover 38 accommodated accordingly, the interior of the main body case 30 is divided into a front space (a first space) FS which is defined on a front side (a side where the keyboard 20 is provided) of the key cover 38 and a back space BS (a second space) which is defined on a back side (a side where loudspeakers 50R, 50L, which will be described later, are provided) of the key cover 38. In other words, the interior of the main body case 30 is divided into a region on the front side of the key cover 38 and a region on the back side of the key cover 38. With the key cover 38 accommodated in the interior of the main body case 30, the outside of the main body case 30 and the front space FS are made to communicate with each other via the attachment openings 14a.

As shown in FIGS. 5 and 6, a second metallic sheet 16, which extends in the left-right direction, is attached to a lower surface of the front top plate 36F (not shown in FIG. 3). In a sectional view shown in FIG. 5, the second metallic sheet 16 is formed substantially into a stepped structure from a front lower side to a back upper side, and the operation plate 18, having a thick substantially rectangular plate-like shape which is elongated in the left-right direction, is provided at a front end portion of a lower section of the second metallic sheet 16 in such a posture that two sheet surfaces thereof are oriented in the front-back direction. The operation plate 18 is provided between the key cover 38 and the front top plate 36F in such a manner as to define gaps on both upper and lower sides thereof in such a manner as to be opened towards the front side. Most of a gap defined between the key cover 38 and the front top plate 36F is covered by the operation plate 18, whereby the back space BS is made invisible. A part of a front surface of the operation plate 18 is made into a touch panel, where multiple switches, not shown, are provided to receive touch operations. As a result, the operation plate 18 has a touch operation detection mechanism for enabling a touch operation and an LED illuminating mechanism for emitting light for illuminating the switches in an interior thereof.

A perforated unit 40, having a substantially rectangular plate-like shape which is elongated in the left-right direction, is attached to a front end portion of an upper section of the second metallic sheet 16 of the stepped structure with screws in such a posture that two plate surfaces thereof are oriented in the front-back direction. The perforated unit 40 is formed from a resin through injection molding and includes multiple holes which are provided in such a manner as to penetrate the perforated unit 40 in a thickness direction thereof. The perforated unit 40 is provided on the second metallic sheet 16 on a back side of the operation plate 18 in such a manner as to define a slight gap in the front-back direction between the operation plate 18 and itself. As shown in FIG. 5, a lower portion of the perforated unit 40 overlaps the operation plate 18 in the front-back direction.

As shown in FIGS. 2 and 3, the electronic keyboard instrument 1 includes two loudspeakers (sound emitting units) 50R, 50L on a back side of an upper surface of the lower plate 37 in the back space BS. The two loudspeakers 50R, 50L are provided downwards and backwards of the keyboard 20 in such a manner that sound emitting sections 50R1, 50L1, each having a shape of frustum of circular cone, are disposed above the lower plate 37. Sounds emitted from the sound emitting sections 50R1, 50L1 are emitted into the back space BS. Of the two loudspeakers 50R, 50L, the loudspeaker 50R (hereinafter, also referred to as a “right loudspeaker 50R”) is provided on the upper surface of the lower plate 37 in a position lying closer to the right side and functions to emit sounds in a high-pitched sound range. The other loudspeaker 50L (hereinafter, also referred to as a “left loudspeaker 50L”) is provided on the upper surface of the lower plate 37 in a position lying closer to the left side in such a manner as to be aligned parallel to the right loudspeaker 50R in the left-right direction and functions to emit sounds in a low-pitched sound range.

Two reflection units 60 are provided in such a manner as to be aligned side by side in the left-right direction on a back side of the upper surface of the lower plate 37 while being disposed between the two loudspeakers 50R, 50L, specifically, in a position lying closer to a central portion in the left-right direction to reflect sounds emitted from the two loudspeakers 50R, 50L. The reflection units 60 are each made up of a screw-fastened section 62 of a thick plate-like shape which is attached to the upper surface of the lower plate 37 with screws and a raised section 64 of a thick plate-like shape which is raised substantially perpendicularly from one longitudinal side portion of the screw-fastened section 62. A surface of the raised section 64 of each reflection unit 60 which is oriented to the front side is made into a reflection surface 64a which is configured to reflect sound. Each reflection unit 60 is disposed in such a posture that the reflection surface 64a is slightly inclined towards the right loudspeaker 50R with respect to the left-right direction. In consequence of this, at least a part of sound emitted from the right loudspeaker 50R is reflected towards the front side and a substantially central portion in the left-right direction by the individual reflection surfaces 64a.

As shown in FIG. 5, a tweeter 70L is provided on a back side of the perforated unit 40 in the back space BS in a position lying obliquely upwards to the front side from the left loudspeaker 50L. Although not shown in FIG. 5, a tweeter is also provided in a position lying obliquely upwards to the front side from the right loudspeaker 50R, similarly, on the back side of the perforated unit 40. The tweeter 70L and the other tweeter each have a substantially circular cylindrical shape and are attached individually to the second metallic sheet 16 via a submetallic sheet 17, which is attached to an internal surface of the second metallic sheet 16 in such a manner that a cylindrical axis direction and a sound emitting direction are oriented to a forward and obliquely upward direction (towards the perforated unit 40).

In addition, as shown in FIG. 3, two upwardly opened concave recesses 39R, 39L are provided in the lower plate 37. Specifically speaking, the two recesses 39R, 39L are provided slightly inwards of the corresponding loudspeakers 50R, 50L in the left-right direction (at a substantially central portion of the lower plate 34 in the left-right direction) and slightly forwards of the corresponding loudspeakers 50R, 50L in the front-back direction. The two recesses 39R, 39L are exposed towards the key cover 38 (in other words, in such a manner as to face the key cover 38) in the interior of the main body case 30 and are provided on a plate surface of the lower plate 37 which lies closer to the key cover 38. Openings of the individual recesses 39R, 39L are each formed into a substantially rectangular shape of which four corners are angularly rounded as viewed from above. Hereinafter, the recess 39R which is provided closer to the right loudspeaker 50R will also be referred to as a right recess (a high-pitched sound recess) 39R, and the recess 39L which is provided closer to the left loudspeaker 50L will also be referred to as a left recess (a low-pitched sound recess) 39L. A left-right dimension of the opening of the right recess 39R is made one size larger than a left-right dimension of the opening of the left recess 39L, and thus, the right recess 39R is provided one size larger than the left recess 39L.

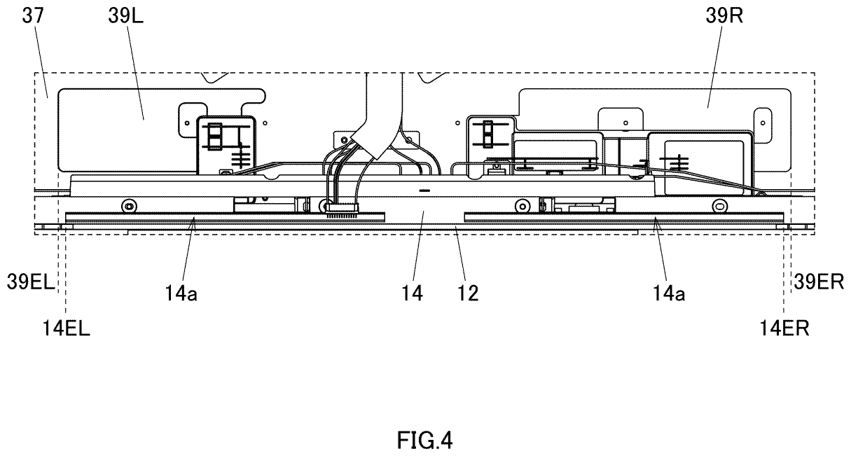

As shown in FIG. 3, when the main body case 30 is seen from above or in a plan view of the main body case 30 with a player M disposed at a substantially central portion of the keyboard 20 in the left-right direction in front of the keyboard 20, the recesses 39R, 39L are disposed individually on and in the vicinity of virtual straight lines VL, VL which pass through the corresponding attachment openings 14a to connect the loudspeakers 50R, 50L and the player M. Here, FIG. 4 is an enlarged view of an area surrounding the recesses 39R, 39L and the attachment openings 14a (an area surrounded by broken lines) in FIG. 3. As shown in FIG. 4, an external end portion 39ER of the right recess 39R and an external end portion 14ER of the right attachment opening 14a are positioned in a substantially same position in the left-right direction, and an external end portion 39EL of the left recess 39L and an external end portion 14EL of the left attachment opening 14a are positioned in a substantially same position in the left-right direction.

As shown in FIGS. 5 and 6, inner surfaces of the recesses surfaces substantially 39R, 39L constitute perpendicular to the lower plate 37. With the key cover 38 accommodated in the interior of the main body case 30, the recesses 39R, 39L are provided on the lower plate 37 in positions facing the back cover section 38b of the key cover 38 and are provided in such a manner as to straddle the front space FS and the back space BS. In other words, with the key cover 38 accommodated inside the main body case 30, the recesses 39R, 39L establish a communication between the front space FS and the back space BS. Specifically speaking, center positions of the recesses 39R, 39L in the front-back direction (a center position) CL substantially coincide with center positions of the back cover section 38b of the key cover 38 which adopts a substantially perpendicular posture relative to the lower plate 37 and the back attachment 15. In addition, a depth dimension D1 of each of the recesses 39R, 39L is made substantially a half of a thickness dimension W1 of the lower plate 37.

In the present embodiment, at least a part of sound emitted from the right loudspeaker 50R is configured to pass through an interior of the right recess 39R to reach the front space FS. Then, at least a part of sound emitted from the left loudspeaker 50L is configured to pass through an interior of the left recess 39L to reach the front space FS. Here, sound in a high-pitched sound range is characterized in that the high-pitched sound hardly reaches a nearer side of the main body case 30, while sound in a low-pitched sound range is characterized in that the low-pitched sound easily reaches the nearer side of the main body case 30. In the present embodiment, since the right recess 39R is provided one size larger than the left recess 39L, sound in the high-pitched sound range which is emitted from the right loudspeaker 50R and passes through the interior of the right recess 39R to reach the front space FS is made to reach the front space FS more easily than sound in the low-pitched sound range which is emitted from the left loudspeaker 50L and passes through the interior of the left recess 39L to reach the front space FS.

The recesses 39R, 39L are provided to extend as far as a position where they do not overlap the corresponding loudspeakers 50R, 50L. Although the recesses 39R, 39L are preferably provided to extend as far as the vicinity of the corresponding loudspeakers 50R, 50L, since holes are provided around the loudspeakers 50R, 50L to attach the loudspeakers 50R, 50L to the lower plate 37, the recesses 39R, 39L only need be provided over a distance which can secure the strength of the lower plate 37. As a result of the recesses 39R, 39L being provided to extend as far as the vicinity of the loudspeakers 50R, 50L, sounds emitted from the loudspeakers 50R, 50L are made to easily reach the right recess 39R and the left recess 39L, thereby making it possible to enhance the sound releasing effect of sound traveling paths which extend by way of the right recess 39R and the left recess 39L.

Subsequently, configurations of constituent components provided in the front space FS will be described. As shown in FIGS. 5 and 6, a first support (a support unit) 80 is provided on the front sides of the first metallic sheets 13 in the front space FS. The first support 80 is provided over substantially a whole area of the lower side of the keyboard 20 and is laterally elongated as long as the keyboard 20. The first support 80 is a hollow component which is opened downwards. The keyboard 20 is supported on the main body case 30 by the first support 80 and a second support 88, which will be described later. The second metallic sheet 16 described above is provided on a back side of the first support 80. The recesses 39R, 39L are provided to extend as far as a position where they do not overlap the first support 80 in the front-back direction.

A front end portion of the first support 80 is made into a convex section 80a which protrudes upwards into a convex shape. A portion of the first support 80 which is positioned on lower sides of the black keys 22B of the keys 22 is made into a platform section 80b which protrudes upwards into a platform-like shape. A portion of the first support 80 lying between the convex section 80a and the platform section 80b is made into a concave section 80c which is recessed downwards into a concave shape. A rotatable fulcrum portion 80b1 is provided at a back portion of an upper surface of the platform section 80b so as to support rotatably back end portions of the keys 22 of the keyboard 20. Additionally, a control substrate 85 is provided on the upper surface of the platform section 80b. Switches are provided on the control substrate 85 so as to produce sounds corresponding to the keys 22 which are pressed. Multiple concave section openings 80d, which are opened in the front-back direction and the left-right direction, are provided in the concave section 80c in such a manner as to be aligned side by side in the left-right direction (refer to FIGS. 3 and 6).

Multiple hammers 84, which are connected with the corresponding keys 22, are provided in a part of a space defined inside the first support 80 which lies below the platform section 80b. The hammer 84 includes a substantially triangular weight section 84a and an arm section 84b, which extends in a straight line to the front side from the weight section 84a. The arm section 84b is rotatably supported on a pivot 86 provided in a front portion of the space defined inside the platform section 80b. When the key 22 is pressed, the weight section 84a of the corresponding hammer 84 is raised, whereby a feeling of heaviness can be felt by the player when he or she presses the key 22. This makes it possible to obtain a key press feeling close to that provided by a real piano.

The second support 88 is disposed on the lower plate 37 and is provided in a portion of the space defined inside the first support 80 which lies further forwards than a portion where the hammers 84 are disposed. The second support 88 is a hollow component which is opened downwards and is attached to the main body case 30 by being screwed down onto the lower plate 37. The keyboard 20 is indirectly supported on the main body case 30, which is made of wood, via the first support 80 by the second support 88. The pivot 86 which supports the arm section 84b of the hammer 84 is provided on the second support 88.

Subsequently, communication paths P1 to P4 will be described. The communication paths P1 to P4 are provided in the interior of the main body case 30 and constitute sound travelling paths for sounds emitted from the loudspeakers 50R, 50L. As shown in FIG. 5, in the electronic keyboard instrument 1 according to the present embodiment, four communication paths P1 to P4 are provided inside the main body case 30 as sound travelling paths along which sounds emitted from the two loudspeakers 50R, 50L travel to reach the outside of the main body case 30. A first communication path P1, which is a first communication path, constitutes a communication path along which sounds emitted from the two loudspeakers 50R, 50L travel by way of the interiors of the recesses 39R, 39L to reach the front space FS, pass underneath the hammers 84 to travel further from the concave section openings 80d to above the first support 80, and passes through interspaces defined between the keys 22 to eventually reach the outside of the main body case 30.

A second communication path P2, which is a second communication path, constitutes a communication path along which sounds emitted from the two loudspeakers 50R, 50L travel by way of the interiors of the recesses 39R, 39L to reach the back sides of the first metallic sheets 13, pass upwards around the back sides of the first metallic sheets 13, and travel further from the attachment openings 14a to eventually reach the outside of the main body case 30. Here, in the present embodiment, most of the sounds which are released to the outside of the main body case 30 by way of the first communication path P1 and the second communication path P2 pass through the interiors of the recesses 39R, 39L to reach the front space FS. As a result, even in the case that a gap defined between the back cover section 38b and the lower plate 37 is small, sounds emitted from the two loudspeakers 50R, 50L to travel by way of the first communication path P1 and the second communication path P2 are made to reach the front space FS from the back space BS efficiently.

Here, at least a part of sound emitted from the right loudspeaker 50R to travel by way of the first communication path P1 and the second communication path P2 is reflected towards the right recess 39R by the reflection surfaces 64a of the reflection units 60 which are disposed in such a manner as to be inclined towards the right loudspeaker 50R and then passes through the interior of the right recess 39R to eventually reach the back sides of the first metallic sheets 13. As a result, sound in the high-pitched sound range emitted from the right loudspeaker 50R is made to reach the back sides of the first metallic sheets 13 efficiently.

A third communication path P3, which is a third communication path, constitutes a communication path along which sounds emitted from the two loudspeakers 50R, 50L travel upwards through the back space BS, pass through the holes provided in the perforated unit 40, and eventually reach the outside of the main body case 30 from the gap defined between the operation plate 18 and the front top plate 36F. Here, sounds emitted from the tweeter 70L and the other tweeter pass through the holes provided in the perforated unit 40 to eventually reach the outside of the main body case 30, and hence, the sounds travel by way of a part of the third communication path P3. A fourth communication path P4, which is a fourth communication path, constitutes a communication path along which sounds emitted from the two loudspeakers 50R, 50L travel upwards through the back space BS to eventually reach the outside of the main body case 30 by way of the upper openings 11a in the cover plate 11. In this way, the electronic keyboard instrument 1 includes the four communication paths P1 to P4 for releasing sounds, thereby making it possible to obtain a good sound image.

Here, the electronic keyboard instrument 1 according to the present embodiment will be described in comparison with the related technology. In the electronic keyboard instrument of JP-A-2012-145803, sound emitted from the surface loudspeaker unit to the front side passes through the opening provided in the instrument main body to be released towards the player's side. However, the keyboard lid is opened and is then accommodated in the interior of the instrument main body, and the back end portion of the keyboard section is positioned below the center position of the surface loudspeaker unit. Hence, in the sound travelling path which passes underneath the back end portion of the keyboard lid to reach the keyboard, the sound travelling path gets narrow, and thus, sound emitted from the surface loudspeaker unit to travel towards the keyboard is not released sufficiently, resulting in a risk that a good sound image cannot be obtained. In addition, when a sufficient space for releasing sound is provided below the back end portion of the keyboard lid, a problem is caused in that the size of the instrument main body is increased.

In contrast with this, according to the present disclosure, in the configuration in which the key cover is accommodated in the interior of the casing, there can be provided the electronic instrument and the electronic keyboard instrument which enable a good sound image to be obtained while saving the space in the interior of the casing.

To obtain the above-described advantage, the electronic keyboard instrument 1 according to the present embodiment includes the main body case 30, the keyboard 20 which is provided on the main body case 30 and has the multiple keys 22, the two loudspeakers 50R, 50L which are provided in the interior of the main body case 30, and the key cover 38 which is accommodated in the space defined between the key board 20 and the two loudspeakers 50R, 50L by being pushed into and pulled out of the relevant space in the interior of the main body case 30 and covers the keyboard 20 in such a state that the key cover 38 is pulled out of the interior of the main body case 30. Then, with the key cover 38 kept accommodated in the interior of the main body case 30, the interior of the main body case 30 is divided into the front space FS defined on the side where the keyboard 20 is provided and the back space BS defined on the side where the two loudspeakers 50R, 50L are provided by the key cover 38. In addition, the electronic keyboard instrument 1 has the recesses 39R, 39L which are exposed towards the key cover 38 in the interior of the main body case 30 and are provided on the plate surface of the lower plate 37 which lies closer to the key cover 38 in such a manner as to straddle the front space FS and the back space BS.

In the electronic keyboard instrument 1 configured in the way described above, even in the case that the gap defined the key cover 38 and the lower plate 37 is small in such a state that the key cover 38 is accommodated inside the main body case 30, a sufficient sound travelling path which reaches the front space FS where the keyboard 20 is provided from the back space BS where the two loudspeakers 50R, 50L are provided can be secured by the recesses 39R, 39L which are provided on the lower plate 37 without increasing the size of the main body case 30. As a result, with the electronic keyboard instrument 1, a good sound image can be obtained by saving the space in the interior of the main body case 30 while realizing the configuration in which the key cover 38 is accommodated in the interior of the main body case 30.

In the electronic keyboard instrument 1 according to the present embodiment, the key covers 38 has the attachment openings 14a which are provided in the hand-held section of the front attachment 14 in such a manner as to establish a communication between the outside of the main body case 30 and the front space FS with the key cover 38 accommodated in the interior of the main body case 30. According to this configuration, there is formed in the interior of the main body case 30 the sound traveling path which extends from the back space BS where the two loudspeakers 50R, 50L are provided, passes through the recesses 39R, 39L to reach the front space FS, and eventually reaches the outside of the main body case 30 from the attachment openings 14a. This can provide the specific configuration of the sound traveling path along which sound travels by way of the recesses 39R, 39L from the back space BS.

In the electronic keyboard instrument 1 according to the present embodiment, when the main body case 30 is seen from above or in the plan view of the main body case 30 with the player M disposed on the front side in the longitudinal direction of the keys 22 of the keyboard 20 (in the front-back direction) and at the substantially central portion in the alignment direction of the keys 22 of the keyboard 20 (in the left-right direction), the attachment openings 14a are provided only on and in the vicinity of virtual straight lines VL which connect the loudspeakers 50R, 50L and the player M. As a result, when compared with a case in which the attachment opening 14a is provided over a substantially whole area of the front attachment 14, sounds emitted from the two loudspeakers 50R, 50L can be released from the individual attachment openings 14a towards the player M by way of the individual recesses 39R, 39L effectively while securing the strength of the front attachment 14, the concealing function, and the design property.

In the electronic keyboard instrument 1 according to the present embodiment, the respective external end portions 39ER, 39EL of the recesses 39R, 39L and the respective external end portions 14ER, 14EL of the attachment openings 14a are made substantially equal in position or coincide with each other in the left-right direction. As a result, the configuration can be realized in which sounds emitted from the two loudspeakers 50R, 50L to reach the back sides of the first metallic sheets 13 after passing through the recesses 39R, 39L from the back space BS are made to reach the individual attachment openings 14a easily, thereby making it possible to enhance the sound releasing effect of sound which is released from the attachment openings 14a to the outside of the main body case 30.

The electronic keyboard instrument 1 according to the present embodiment includes the first support 80 for supporting the keyboard 20 on the main body case 30, and the recesses 39R, 39L are provided to extend as far as the position where they do not overlap the first support 80. In this way, by providing the recesses 39R, 39L of the largest possible size in the limited space in the interior of the main body case 30, the sound releasing effect of sound which is released to the outside of the main body case 30 by way of the recesses 39R, 39L can be enhanced while saving the space in the interior of the main body case 30. Further, the first support 80 can be fixed to the lower plate 37 stably.

In the electronic keyboard instrument 1 according to the present embodiment, the loudspeakers 50R, 50L include the left loudspeaker 50L which is provided on the one side in the left-right direction in the interior of the main body case 30 to emit sound in the low-pitched sound range and the right loudspeaker 50R which is provide on the other side in the left-right direction in the interior of the main body case 30 to emit sound in the high-pitched sound range. Then, the recesses 39R, 39L include the left recess 39L which is provided closer to the left loudspeaker 50L and the right recess 39R which is provided closer to the right loudspeaker 50R. Further, the opening of the right recess 39R is made larger than the opening of the left recess 39L. According to this configuration, sound in the high-pitched sound range emitted from the right loudspeaker 50R is made to travel by way of the right recess 39R whose opening is made larger, so that the sound so travelling is made to reach the nearer side easily. As a result, the irregularity in the magnitude of volume of sound reaching the nearer side, that is, the player's side is restrained from scattering locally in the left-right direction, thereby making it possible to enhance the uniformity in the magnitude of volume of sound reaching the player.

In the electronic keyboard instrument 1 according to the present embodiment, the respective openings of the recesses 39R, 39L are formed into the substantially rectangular shape when the electronic keyboard instrument 1 is seen from above or in the plan view of the electronic keyboard instrument 1. According to this configuration, when compared with a case in which the respective openings of the recesses 39R, 39L are formed into a substantially circular shape, the size of the openings can be increased. As a result, sound travelling from the back space BS to reach the front space FS by way of the recesses 39R, 39L can be made to so reach the front space FS, thereby making it possible to enhance the sound releasing effect of sound which is released to the outside of the main body case 30.

In the electronic keyboard instrument 1 according to the present embodiment, the key cover 38 has the front cover section 38a and the back cover section 38b which are coupled together in the longitudinal direction (the front-back direction) of the keys 22 of the keyboard 20. Then, the key cover 38 is accommodated in the interior of the main body case 30 in such a posture that the front cover section 38a becomes substantially horizontal or parallel relative to the lower plate 37, and the key cover 38 is accommodated in the interior of the main body case 30 in such a posture that the back cover section 38b becomes substantially perpendicular relative to the lower plate 37. Further, the center positions of the recesses 39R, 39L in the front-back direction substantially coincide with the center position of the back cover section 38b in the front-back direction. According to this configuration, in each of the recesses 39R, 39L, the size of an opening that straddles the front space FS and the size of an opening that straddles the back space BS become substantially equal, and hence, sound can be made to reach the front space FS from the back space BS by way of the recesses 39R, 39L efficiently, thereby making it possible to enhance the sound releasing effect of sound which is released to the outside of the main body case 30.

In the electronic keyboard instrument 1 according to the present embodiment, the depth dimension D1 of the recesses 39R, 39L is made substantially the half of the thickness dimension W1 of the lower plate 37. According to this configuration, the strength of the lower plate 37 can be secured while securing the sound travelling path of sound passing through the recesses 39R, 39L.

Here, the embodiment that have been described heretofore is presented as an example, and hence, there is no intention to limit the scope of the present invention by the embodiment. This novel embodiment can be carried out in other various forms, and various omissions, replacements, and modifications can be made thereto without departing from the spirit and scope of the present invention. Those resulting embodiments and modified examples thereof are included in the scope and gist of the present invention and are also included in the scope of inventions claimed for patent under claims below and their equivalents.

For example, in the present embodiment that has been described heretofore, the configuration is described in which in total, two loudspeakers are provided one on each of the left and right sides of the upper surface of the lower plate, however, the present invention is not limited thereto, and hence, for example, a configuration may be adopted in which in total, four loudspeakers are provided two on each of the left and right sides of the upper surface of the lower plate. Even with this configuration, a recess is provided in such a manner as to correspond to the two loudspeakers provided on each of the left and right sides of the upper surface, thereby making it possible to realize an electronic keyboard instrument in which a good sound image can be obtained. In addition, in the embodiment that has been described heretofore, the configuration is described in which the recesses are provided on the lower plate, however, the present invention is not limited thereto, and hence, a configuration may be adopted in which, for example, in the case that another component plate such as a reinforcement plate or the like is laid over the upper side of the lower plate, the recesses are provided on the component plate so laid. Further, in the case that multiple component plates are provided on the upper side of the lower plate, the recesses are provided on an uppermost component plate, that is, a component plate which is exposed towards the key cover.

What is claimed is:

1. An electronic instrument comprising:
a casing;
at least one performance element provided in connection with the casing;
a sound emitting unit provided in an interior of the casing; and
a cover unit configured to be accommodated between the at least one performance element and the sound emitting unit in the interior of the casing by being pushed into and pulled out of the interior of the casing and to cover the at least one performance element in a state in which the cover unit is pulled out of the interior of the casing,
wherein the interior of the casing is divided by the cover unit into a first space on a side where the at least one performance element is disposed and a second space on a side where the sound emitting unit is disposed in a state in which the cover unit is accommodated in the interior of the casing, and
wherein a recess is provided on a plate surface lying near the cover unit in the interior of the casing in such a manner as to straddle the first space and the second space.

2. The electronic instrument according to claim 1,
wherein the at least one performance element comprises multiple performance elements, and the multiple performance elements are aligned in a left-right direction of the casing and each of the multiple performance elements is provided to extend in a front-back direction of the casing,
wherein the casing comprises a bottom plate provided below the multiple performance elements, and
wherein the recess is provided on a plate surface of the bottom plate.

3. The electronic instrument according to claim 2,
wherein the cover unit comprises a communication hole provided in a hand-held section for establishing a communication between an outside of the casing and the first space in such a state that the cover unit is accommodated in the interior of the casing.

4. The electronic instrument according to claim 3,
wherein when the electronic instrument is seen from above or in a plan view of the electronic instrument with a player disposed on a front side and at a substantially central portion in the left-right direction of the multiple performance elements, the recess is provided on and near a virtual line which connects the sound emitting unit and the player.

5. The electronic instrument according to claim 4,
wherein an external end portion of the recess and an external end portion of the communication hole are positioned in a substantially same position in the direction in which the multiple performance elements are aligned.

6. The electronic instrument according to claim 3,
wherein when the electronic instrument is seen from above or in a plan view of the electronic instrument with a player disposed on front side and at a substantially central portion in the left-right direction of the multiple performance elements, the communication hole is provided on and near a virtual line which connects the sound emitting unit and the player.

7. The electronic instrument according to claim 1, further comprising:
a support unit provided on a side where the first space is defined and configured to support the at least one performance element on the casing,
wherein the recess is provided to extend as far as a position where the recess does not overlap the support unit in a front-back direction of the casing.

8. The electronic instrument according to claim 2,
wherein the sound emitting unit comprises a low-pitched sound emitting unit provided on one side in the left-right direction in the interior of the casing and configured to emit a low-pitched sound and a high-pitched sound emitting unit provided on an other side in the left-right direction in the interior of the casing and configured to emit a high-pitched sound,
wherein the recess comprises a low-pitched sound recess provided closer to the low-pitched sound emitting unit and a high-pitched sound recess provided closer to the high-pitched sound emitting unit, and
wherein an opening of the high-pitched sound recess is made larger than an opening of the low-pitched sound recess.

9. The electronic instrument according to claim 8,
wherein the recess is provided closer to the central portion in the left-right direction than the low-pitched sound emitting unit and the high-pitched sound emitting unit.

10. The electronic instrument according to claim 1,
wherein when the electronic instrument is seen from above or in a plan view of the electronic instrument, an opening of the recess has a substantially rectangular shape.

11. The electronic instrument according to claim 2,
wherein the cover unit comprises a first cover and a second cover which are coupled together in the front-back direction, the cover unit being accommodated in the interior of the casing in such a posture that the first cover becomes substantially horizontal relative to the bottom plate and being accommodated in the interior of the casing in such a posture that the second cover becomes substantially perpendicular to the bottom plate, and
wherein a center position in the front-back direction of the recess substantially coincides with a center position of the second cover when the second cover adopts a substantially perpendicular posture.

12. The electronic instrument according to claim 2,
wherein a depth dimension of the recess is made substantially a half of a thickness dimension of the bottom plate.

13. An electronic keyboard instrument comprising:
the electronic instrument according to claim 1, wherein the electronic instrument comprises multiple performance elements, and the multiple performance elements include a keyboard.
